(19) United States
(12) Patent Application Publication
(10) Pub. No.: US 2014/0327521 A1
(43) Pub. Date: Nov. 6, 2014

(54) ASSET LOCATION USING RELAYS

(71) Applicant: QUALCOMM Incorporated, San Diego, CA (US)

(72) Inventors: An Mei Chen, San Diego, CA (US); Jangwon Lee, San Diego, CA (US); Vijaya Datta Mayyuri, San Diego, CA (US); Paul David Milne, Oceanside, CA (US); Robert M. Morandy, San Diego, CA (US)

(73) Assignee: QUALCOMM Incorporated, San Diego, CA (US)

(21) Appl. No.: 14/056,672

(22) Filed: Oct. 17, 2013

Related U.S. Application Data
(60) Provisional application No. 61/818,430, filed on May 1, 2013.

(51) Int. Cl. G08C 17/02

(52) U.S. Cl. CPC G08C 17/02
USPC 340/8.1

(57) ABSTRACT

Systems and methods are described herein for asset location using relay tags. A method for asset location via a relay tag as described herein includes receiving, at the relay tag, an asset message from an asset tag according to a wireless communication protocol, wherein the relay tag has a known location; producing, at the relay tag, a relay message using information contained in the asset message, wherein the relay message includes an indication of the relay tag from which the relay message is sent and an indication of the asset tag from which the asset message was received; and sending the relay message from the relay tag to a receiver using the wireless communication protocol.

### CROSS-REFERENCE TO RELATED APPLICATIONS

This application claims the benefit of U.S. Provisional Application No. 61/818,430, filed May 1, 2013, entitled “ASSET LOCATION USING RELAYS,” which is incorporated herein by reference in its entirety for all purposes.

### FIELD

This application relates generally to wireless communications, and more particularly to leveraging wireless communication to determine positions of objects.

### BACKGROUND

Asset tracking systems are used to assist in a variety of tasks, such as inventory control, manufacturing status tracking, etc. As the use of asset tracking systems becomes more widespread, it is becoming increasingly desirable to implement an efficient and practical indoor asset tracking system. One desirable feature of such an indoor asset tracking system is longevity of the components of the system. This may be considered in terms of durability, battery life, etc. For example, it is desirable for an asset tag used for positioning of an associated object to have a long battery life (e.g., 2-3 years or greater).

### SUMMARY

A method for asset location via a relay tag is described herein. The method includes receiving, at the relay tag, an asset message from an asset tag according to a wireless communication protocol, wherein the relay tag has a known location; producing, at the relay tag, a relay message using information contained in the asset message, wherein the relay message includes an indication of the relay tag from which the relay message is sent and an indication of the asset tag from which the asset message was received; and sending the relay message from the relay tag to a receiver using the wireless communication protocol.

Implementations of the method may include one or more of the following features. Wirelessly sending a landmark message from the relay tag or a landmark tag to the asset tag, wherein the landmark message indicates presence of at least one relay tag to relay the asset message, and wherein the landmark message is broadcast for receipt by a plurality of asset tags. Receiving, at the asset tag, the landmark message; and setting, at the asset tag, an amount of time that the asset tag sleeps between periods of listening for landmark messages to a first amount of time; wherein the first amount of time is longer than a second amount of time for which the asset tag sleeps between listening for landmark messages, the second amount of time being set by the asset tag if no relay tags are indicated to be present within communication range of the asset tag. The asset tag intermittently listens for the landmark message during listen periods of a listen duration, and the asset tag responds to receiving the landmark message by decreasing the listen duration. Receiving, at the asset tag, the landmark message; and setting, at the asset tag, an asset message transmission power to a first power; wherein the first power is lower than a second power, the second power being set by the asset tag for the asset message transmission power if no relay tags are indicated to be present within communication range of the asset tag.

Implementations of the method may also or alternatively include one or more of the following features. The receiving includes receiving the asset message at a plurality of relay tags with known locations; and the method further includes determining a received signal strength indication (RSSI) for the asset message at each of the plurality of relay tags, generating, at the relay tags, respective relay messages, the relay messages including indications of the RSSIs determined for the asset tag by the respective relay tags, and sending the relay messages from the relay tags to the receiver using the wireless communication protocol. The asset message is a first asset message, and the method further includes receiving, at the relay tag, a second asset message, analyzing the first asset message and the second asset message based on at least one criterion, disregarding at least a portion of the second asset message in response to the analyzing, and refraining from transmitting a relay message from the relay tag to the receiver corresponding to at least one disregarded portion of the second asset message. Sleeping, at the asset tag, for a sleep duration; listening, at the asset tag, for a landmark message during a listen period; and in response to the landmark message not being received during the listen period, repeating the sleeping for the sleep duration without transmitting the asset message from the asset tag. The wireless communication protocol is a wireless personal area network (WPAN) protocol. The wireless communication protocol is a low-power wireless communication protocol. Forwarding content of the relay message from the receiver to a server.

An example of a non-transitory processor-readable storage medium associated with a relay tag is described herein. The storage medium includes processor-readable instructions configured to cause a processor of the relay tag to receive an asset message from an asset tag according to a wireless communication protocol; produce a relay message using information contained in the asset message, wherein the relay message includes an indication of the relay tag from which the relay message is sent and an indication of the asset tag from which the asset message was received; and send the relay message to a receiver using the wireless communication protocol.

Implementations of the storage medium may include one or more of the following features. Instructions configured to cause the processor of the relay tag to broadcast a landmark message for receipt by a plurality of asset tags, wherein the landmark message indicates presence of at least one relay tag to relay the asset message. Instructions configured to cause the processor of the relay tag to determine an RSSI for the asset message and include an indication of the RSSI determined for the asset message in the relay message. The asset message is a first asset message, and the instructions include instructions configured to cause the processor of the relay tag to receive a second asset message, analyze the first asset message and the second asset message based on at least one criterion, disregard at least a portion of the second asset message in response to the analyzing, and refrain from transmitting a relay message to the receiver corresponding to at least one disregarded portion of the second asset message.

An example of an asset location system is described herein. The asset location system includes an asset tag configured to be attached to an asset and to transmit an asset message according to a wireless communication protocol; relay tags configured to receive the asset message from the asset tag, to determine an RSSI for the asset message, to generate a relay message including an indication of the relay tag, an indication of the asset tag, and the RSSI, and to transmit the relay message; a receiver configured to receive the relay messages from the relay tags, to generate a receiver message including content of the relay messages, and to transmit the receiver message; and a server configured to receive the receiver message from the receiver and to determine a location of the asset tag using content of the receiver message.

Implementations of the asset location system may include one or more of the following features. The server is configured to determine the location of the asset tag by assigning, as the asset tag location, a known location of one of the plurality relay tags having a highest RSSI for the asset message. The server is configured to determine the location of the asset using trilateration based on known locations of respective relay tags and respective RSSIs determined by the relay tags. A landmark tag configured to send a landmark message to the asset tag using the wireless communication protocol, the landmark message indicating that the system includes the relay tags. The relay tags include the landmark tag.

An example of a relay tag operable in an asset location environment is described herein. The relay tag includes means for receiving an asset message using a wireless communication protocol; means for determining an RSSI for the asset message; means for producing a relay message using information contained in the asset message, wherein the relay message includes an indication of the relay tag, an indication of the asset tag, and the RSSI determined for the asset message; and means for sending the relay message to a receiver using the wireless communication protocol.

Another example of a relay tag operable in an asset location environment is described herein. The relay tag includes an asset message module configured to receive an asset message using a wireless communication protocol; and a relay message module configured to produce a relay message using information contained in the asset message, wherein the relay message includes an indication of the relay tag from which the relay message is sent and an indication of the asset tag from which the asset message was received, and to send the relay message to a receiver using the wireless communication protocol.

Items and/or techniques discussed herein may provide one or more of the following capabilities, as well as other capabilities not mentioned. The granularity of information communicated within an asset tracking system may be improved. Relays may be utilized within an asset tracking system, thereby boosting the range of asset tracking without reducing the battery life of system components. Components of an asset tracking system, such as asset tags, may exhibit improved battery life, and regional power control and/or other finely granular power control techniques can be utilized to fine-tune the battery usage of system components. Other capabilities may be provided and not every implementation according to the disclosure must provide any, let alone all, of the capabilities discussed. Further, it may be possible for an effect noted above to be achieved by means other than that noted, and a noted item/technique may not necessarily yield the noted effect.

### BRIEF DESCRIPTIONS OF THE DRAWINGS

FIG. 1 is a block diagram of an asset tracking environment including an asset tracking system.

FIG. 2 is a block diagram of an asset tag shown in FIG. 1.

FIG. 3 is a block diagram of a landmark tag shown in FIG. 1.

FIG. 4 is a block diagram of a receiver tag shown in FIG. 1.

FIG. 5 is a block diagram of a server shown in FIG. 1.

FIG. 6 is a timing diagram of an asset tag listen, transmission, and sleep periods and associated landmark tag sleep and transmission periods.

FIG. 7 is a timing diagram of an asset tag listen period in the absence of an associated landmark tag transmission period.

FIG. 8 is a block diagram of another asset tracking environment.

FIG. 9 is a schematic diagram of two tiers of landmark tag coverage areas.

FIG. 10 is a block diagram of an asset tracking environment using relay tags.

FIG. 11 is a block diagram of a relay tag shown in FIG. 10.

FIG. 12 is a block diagram of an example layout of asset tags and relay tags.

FIG. 13 is a block functional diagram of a relay tag shown in FIG. 10.

FIG. 14 is a block diagram of sample communications between relay tags, a landmark tag, a receiver, and a server shown in FIG. 10.

FIGS. 15-16 are block functional diagrams of a server and an asset tag, respectively, shown in FIG. 10.

FIGS. 17-18 are block flow diagrams of respective processes of locating an asset tag.

FIG. 19 is a block diagram of a location-aware content distribution system.

FIG. 20 is a block diagram of a mobile device shown in FIG. 19.

### DETAILED DESCRIPTION

Techniques described herein provide for asset tracking using an asset tracking system that includes asset tags and relay tags. In general, relay tags may be provided to relay asset messages from asset tags to a receiver. Further, the relay tags may provide additional information such as received signal strength indications corresponding to the received asset messages. As described herein, the relay tags enable landmark tags to be omitted in an asset tracking system, improve asset tracking range, improve asset tag battery life, etc. An example asset tracking system, as well as the asset tags, relay tags, and landmark tags used therein, are described in further detail below.

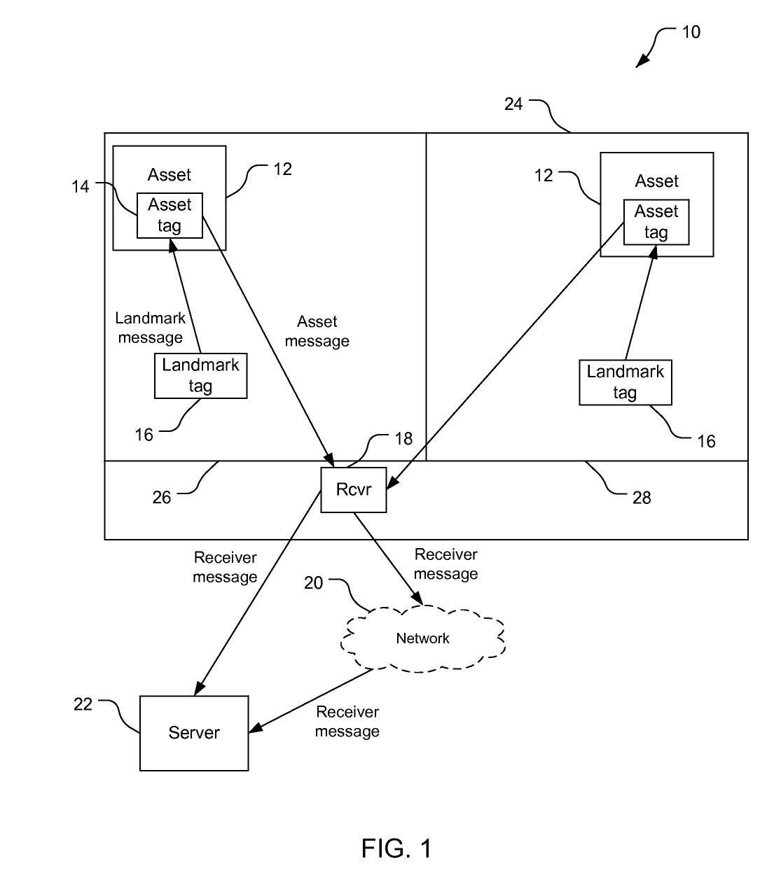

Referring to FIG. 1, an example of an asset tracking environment 10 includes one or more assets 12, each of which may include an asset tag 14. The asset tracking environment 10 may also include landmark tags 16, a receiver 18, a network 20, and a server 22. One or more elements of asset tracking environment 10 may be located within a given area, such as a building 24. Here, the building 24 includes rooms 26, 28, and the asset tags 14, the landmark tags 16, the receivers 18, the network 20, and the server 22 collectively form an asset tracking system. While only one receiver 18 is shown in FIG. 1, more than one receiver 18 may be used. For instance, receivers may be placed in room 26 and/or room 28, and/or in any other suitable locations. Further, the asset tracking system shown in FIG. 1 may include any number of asset tags 14, landmark tags 16, receivers 18, and/or servers 22, in any suitable configuration. Additionally, while the server 22 is shown outside of the building 24 (and communicatively coupled to the remainder of the asset tracking system via a network 20 as described below), the server 22 may alternatively also be located in the building 24.

The asset tags 14 may wirelessly communicate with the landmark tags 16 and/or the receiver 18 via antennas. The asset tags 14 may receive communications, such as landmark messages or other messages as described herein, from the landmark tags 16 using one or more wireless protocols. These protocols may include, but are not limited to, wireless personal area network (WPAN) protocols, such as the Bluetooth® protocol developed by the Bluetooth Special Interest Group (SIG), and/or any other suitable short-range wireless protocol. Bluetooth is a registered trademark of Bluetooth SIG, Inc. While in some implementations the landmark tags 16 communicate with a low-power wireless communication protocol, the landmark tags 16 may communicate with other components of the asset tracking system using any suitable wireless communication protocol.

The asset tags 14 may be configured to send asset messages and/or other communications as described herein to the receiver 18 over the same wireless protocol used for communication from the landmark tags 16 to the asset tags 14 and/or a different protocol.

The receiver 18 may be configured to receive asset messages and/or other communications as described herein originating from the asset tags 14 using the wireless communication protocol(s) associated with the asset tags 14 and/or a different protocol. The receiver 18 may also be configured to send communications to the server 22, either directly or through the network 20. While FIG. 1 illustrates both a direct communication link from the receiver 18 to the server 22 and an indirect communication link from the receiver 18 to the server 22 via the network 20, some implementations may utilize only one of these communication links. If the receiver 18 communicates with the server 22 directly, the network 20 may be omitted from the environment shown in FIG. 1.

The assets 12 may be moved to various locations, such as between the rooms 26, 28 of the building 24 shown in FIG. 1, and/or to other locations within or near the building 24. The assets 12 may include respective asset tags 14. For instance, an asset tag 14 may be affixed to an asset 12 such that the asset tag 14 stays with the asset 12 and is configured to communicate with the landmark tags 16 and/or the receiver 18.

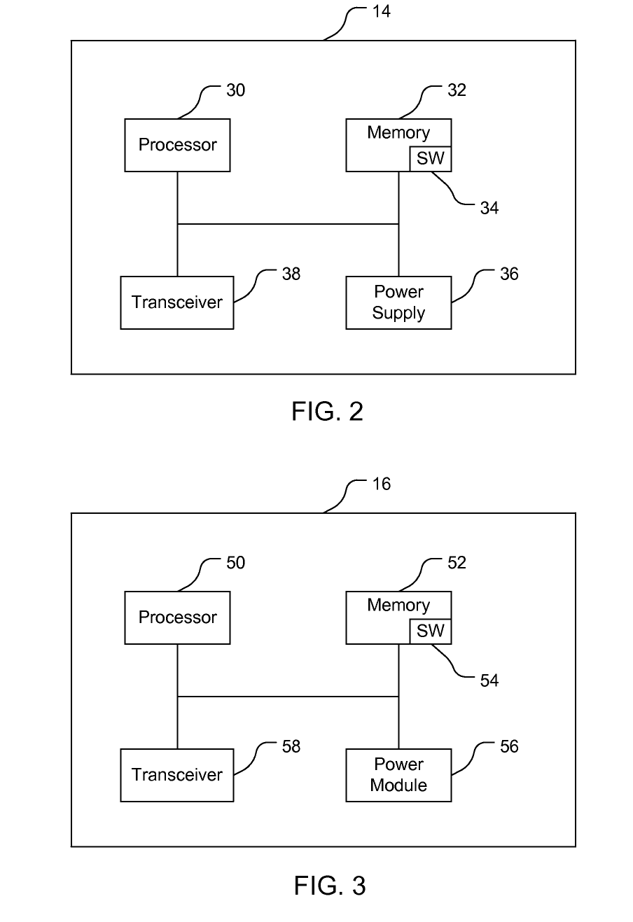

Referring to FIG. 2, an example of an asset tag 14 may include a computer system including a processor 30, a memory 32 including software 34, a power supply 36 (such as a battery), and a transceiver 38. The transceiver 38 is associated with one or more antennas (not shown) and may be configured to communicate with landmark tags 16 and/or a receiver 18 as described herein. The transceiver 38 may be configured to utilize one or more short-range wireless communication protocols, such as Bluetooth® or the like, for communication with other nearby devices.

The processor 30 may be an intelligent hardware device such as, for example, a central processing unit (CPU) including, but not limited to, those made by ARM®, Intel® Corporation, or AMD®; a microcontroller; an application specific integrated circuit (ASIC); etc. The processor 30 may also comprise multiple separate physical entities that may operate in a distributed manner in the asset tag 14.

The memory 32 may be a processor-readable storage medium, and may include random access memory (RAM) and/or read-only memory (ROM). The memory 32 may be configured to store software 34, which is defined herein as processor-readable, processor-executable software code containing processor-readable instructions that are configured to, when executed, cause the processor 30 to perform various functions described herein. Alternatively, the software 34 may not be directly executable by the processor 30 but configured to cause the processor 30, e.g., when compiled and executed, to perform the functions.

An example one of the asset tags 14 is a low-power wireless communication device, which may utilize the Bluetooth® Low Energy (BLE) protocol and/or other short range and/or low power wireless protocols, and is fixed to the asset 12. The asset tag 14 may be a small, inexpensive device (e.g., capable of being manufactured for about $5 or less). The power supply may be a battery, for example, a coin-cell battery, though other power source mechanisms could be used. The asset tag 14 may be configured to intermittently sleep and listen. The intermittent listening may be periodic (e.g., at regular, consistently-spaced intervals) or non-periodic (random, partially periodic and partially aperiodic, and/or other non-periodic schemes). For example, the asset tag 14 may be configured to listen four times a day by sleeping for about six hours, then waking and listening for about five seconds, then sleeping for about another six hours, etc. Other sleep and/or wake intervals could also be utilized.

The processor 30 may be configured to cause the transceiver 38 (for instance, via a WPAN communication module (not shown) and/or other mechanisms associated with the transceiver 38) to sleep and subsequently wake up to listen for landmark messages. Further, the processor 30 may be configured to prepare an asset message that includes information regarding a received landmark message and to send the asset message to the receiver 18. Information in the asset message may include, but is not limited to, information regarding landmark messages received in a most recent listening period, and/or other suitable information. Additionally, the asset message may be provided to the receiver 18 in a broadcast and/or directed fashion.

The asset tag 14 may analyze a landmark message received from a landmark tag 16 to determine a received signal strength of the landmark message (e.g., as a received signal strength indicator or RSSI) and/or to determine an identity of the landmark tag 16 that sent the landmark message. The asset tag 14 may use these data to prepare the asset message such that the asset message includes the corresponding RSSI and landmark tag identifier. If landmark messages are received from multiple landmark tags 16, the asset tag 14 may be configured to include RSSIs and corresponding landmark tag IDs for the different landmark tags 16 from which messages are received.

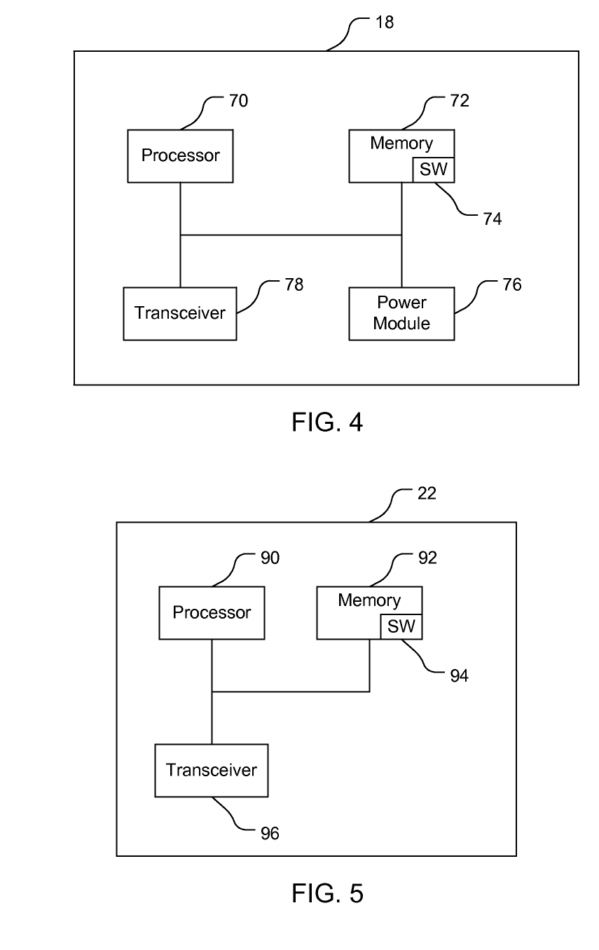

Referring to FIGS. 3-4, the landmark tags 16 and the receiver 18 may in some implementations be similarly (but not necessarily identically) configured to the asset tags 14. For instance, the landmark tags 16 may include a processor 50 and a memory 52 that stores software 54, and the receiver 18 may include a processor 70 and a memory 72 that stores software 74. The processor 50 and memory 52 of the landmark tags 16 and the processor 70 and memory 72 of the receiver may be configured similarly to the processor 30 and the memory 32 of the asset tags 14. Further, the landmark tags 16 may also be inexpensively produced similarly to the asset tags 14. However, in any case the software 54, 74 of the landmark tags 16 and the receiver 18, respectively, may be configured differently from the software 34 of the asset tags 14 in order to implement the different functionality of the landmark tags 16 and the receiver 18 as discussed herein. Further, the landmark tags 16 and the receiver 18 may include power modules 56, 76, respectively, that may be configured to connect to grid power (e.g., a wall outlet) in addition to, or instead of, being powered by batteries. Thus, batteries may not be used or included in the landmark tag 16 or the receiver 18 in some implementations.

The transceiver 58 of the landmark tag 16 may be replaced with a transmitter that lacks receive capability. Also, the transceiver 78 of the receiver 18 may include appropriate means to send receiver messages to and/or otherwise communicate with the server 22, either directly or through the network 20. For example, the transceiver 78 may include appropriate apparatus, such as an antenna, an interface with the processor 70, etc., to transmit and receive wireless communication signals. This communication may take place according to one or more wireless communication standards, which include but are not limited to Wi-Fi, Ethernet, power over Ethernet (PoE), cellular technologies such as 3G and/or 4G, etc., in addition to the WPAN signals and/or other low power, short range communication standards as discussed above.

An example landmark tag 16 is a low-power wireless communication device that has a known location. The landmark tag 16 may have knowledge of its location by being fixed to a particular location, determining its location periodically and/or if moved, being programmed with its location, etc. The landmark tag 16 may be configured to send landmark messages intermittently. Landmark messages may be sent periodically on a regular basis, although periodic transmissions are not required. The landmark tags 16 and the asset tags 14 may be configured such that a listen period (duration) of the asset tag 14 is longer than a cycle time of transmissions of landmark messages from a landmark tag 16, where the cycle time is defined as the time from the beginning of one landmark message to the beginning of the next, consecutive landmark message. The landmark tag 16 may also sleep between transmissions of consecutive landmark messages, with the sleep duration being less than the listen duration of the asset tag 14. The sleep duration of the landmark tag 16 may be much shorter than the listen duration of the asset tag 14. For instance, the sleep duration of the landmark tag 16 may be configured such that at least two landmark messages will be transmitted during one listen duration of the asset tag 14. Generally, the landmark tags 16 are positioned in areas where the assets 12 are to be tracked, and thus within range of where asset tags 14 are expected.

The receiver 18 may provide an observer/central role to listen to asset messages sent by the asset tags 14. For instance, the receiver 18 may processes asset messages and send (forward) data from the asset messages, in a receiver message, to the server 22. The receiver message may be sent directly to the server 22 or indirectly, e.g., via the network 20 which in turn forwards the receiver message to the server 22. The receiver message sent from the network 20 to the server 22 may not be identical to the receiver message sent from the receiver 18 to the network 20. For instance, the header information may be different, and other differences may be present. However, the substantive data (or payload) of the respective messages regarding the landmark message, such as RSSI measurements, corresponding landmark identities, or the like, may be the same between the messages.

The server 22 may be configured to track the asset message data sent by the receiver 18. The server 22 may use these data to determine the position of a particular asset tag 14, and thus the corresponding asset 12. To determine an asset position, the server 22 may store locations corresponding to the landmark tags 16. The server 22 can use position information for a given asset 12 in a variety of ways. These may include, but are not limited to, providing status updates, storing determined positions for reference, initiating actions such as triggering an alarm if a determined asset position is not permitted for the corresponding asset 12, etc.

Referring to FIG. 5, an example of a server 22 comprises a computer system which includes a processor 90, memory 92 including software 94, and a transceiver 96. The transceiver 96 may configured to communicate with the network 20 and/or the receiver 18. The processor 90 may be an intelligent hardware device, e.g., a central processing unit (CPU) such as those made by ARM®, Intel® Corporation, or AMD®, a microcontroller, an application specific integrated circuit (ASIC), etc. The processor 90 could additionally or alternatively comprise multiple separate physical entities that can be distributed in the server 22.

The memory 92 may be a non-transitory processor-readable storage medium, and may include random access memory (RAM) and read-only memory (ROM). The memory 92 may be configured to store data (e.g., in a database) and/or software 94. The software 94 includes processor-readable, processor-executable software code containing processor-readable instructions that are configured to, when executed, cause the processor 90 to perform various functions described herein. Alternatively, the software 94 may not be directly executable by the processor 90 but configured to cause the processor 90, e.g., when compiled and executed, to perform the functions.

Systems may be configured in accordance with one or more of the following specific implementations that are discussed. That is, a single system may be implemented having one or more of selective asset message transmitting, asset locating with fine resolution, asset locating using relay tags, and/or fine-granularity information dissemination.

Selective Asset Message Transmitting

An asset tag 14 may be configured to provide a “no-transmission mode” (no-TX mode), which may also be referred to as an “airplane mode,” a “screen room mode,” and/or by other names, in which asset messages are not sent. It may in some cases be desirable to inhibit or prohibit transmissions from the asset tag 14. For example, in screen rooms where radio frequency (RF) testing is being performed, it is undesirable to have the asset tag 14 transmit an RF signal which may interfere with the testing. As another example, on an airplane, RF transmissions are prohibited to avoid interference with navigation equipment, and thus restricting the asset tag 14 from transmitting RF signals is desirable. As a further example, inhibiting transmissions from an asset tag 14 may reduce power consumption of the asset tag 14, resulting in reduced battery drain and increased battery life. The asset tag 14 may be configured to provide the no-TX mode automatically, e.g., as a default and/or without manual user selection. The asset tag 14 may additionally or alternatively be configured to transmit an asset message only in response to receiving a landmark message. In order to implement selective transmission as described herein, the asset tag 14 may include a transmission means for controlling transmission of asset messages. This transmission means may be implemented by the processor 30, the memory 32 including the software 34, the transceiver 38, and/or any other suitable components of the asset tag 14.

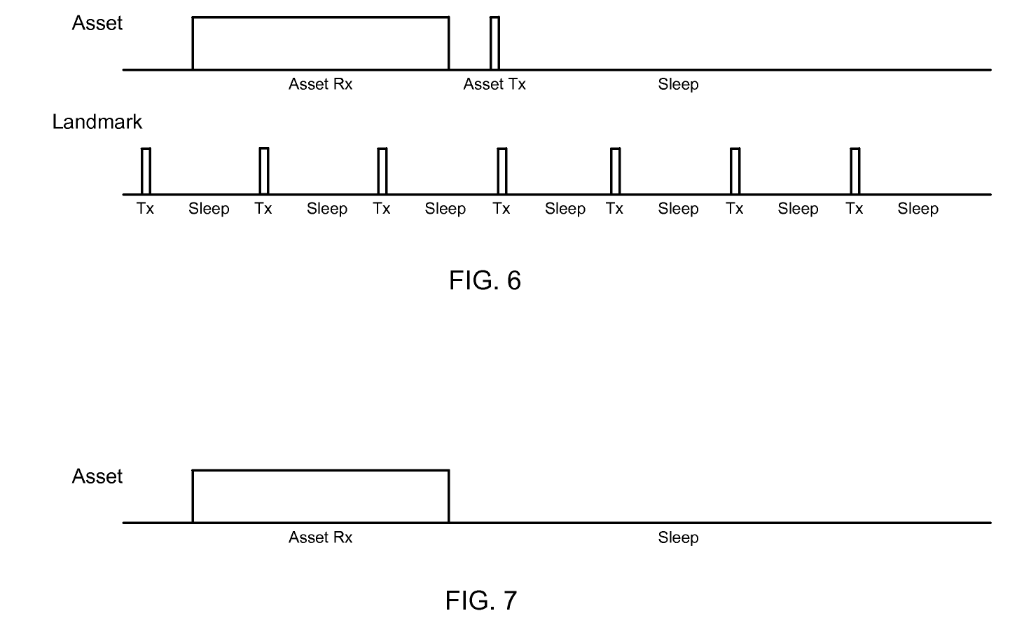

An example of selective asset message transmission is shown in FIGS. 6-7. Referring first to FIG. 6, after a period of sleep, the asset tag 14 wakes up and listens for signals during an asset receive (Asset Rx) period. The asset tag 14 may also analyze received signals during this time. Here, the landmark tags 16 transmit landmark messages at a frequency with a corresponding period that is shorter than the duration of the Asset Rx period. Thus, since the asset tag 14 receives at least one landmark message (in this example, two landmark messages) during and/or after the Asset Rx period (or duration), the asset tag 14 prepares an asset message based on at least one of the received messages. After the end of the Asset Rx period, the asset tag 14 then transmits the asset message during an asset transmission (Asset Tx) period. An asset message transmitted as shown in FIG. 6 may be based on only one of the received landmark messages given that both landmark messages are from the same landmark tag 16. Alternatively, an asset message may be based on multiple landmark messages (e.g., with an RSSI given by the asset message being set to an average and/or other combination of the RSSIs landmark messages received during the Asset Rx period). As another alternative, an asset receive period may be terminated early in response to receiving a landmark message, at which time an asset message may be prepared and sent without waiting for expiry of the entire non-truncated asset receive period.

Referring next to FIG. 7, there are no landmark signals for the asset tag 14 to hear, in contrast to the transmissions shown in FIG. 6. Thus, the asset tag 14 wakes up and listens during the Asset Rx period and receives no landmark messages during the Asset Rx period. Consequently, the asset tag 14 neither prepares nor sends an asset message following the Asset Rx period. In this manner, the asset tag 14 provides an automatic no-TX mode that can be useful for inhibiting undesired communications. These communications may include transmissions from the asset tag 14 in an undesired area such as an airplane, a screen room (defined as a room in which wireless transmission testing is occurring where asset tag transmission could interfere with the wireless transmissions and thus impede accurate testing), an area where eavesdropping may occur (and information collected used without permission or even illegally), etc.

Based on the above, for areas where asset tag transmissions or landmark tag transmissions are undesirable, the asset tags 14 can be inhibited from receiving landmark messages. To prevent an asset tag 14 from receiving landmark messages, no landmark tags 16 may be placed in areas of undesired asset tag transmissions, and any existing landmark tags 16 in such areas may be removed. As another example, an area in which tag transmissions are undesirable can be isolated from transmissions that are external to (outside of) the area from coming into the area. This may be achieved by using anechoic materials and/or other radio frequency insulation.

Asset Locating with Fine Resolution

Locating assets with fine granularity (e.g., less than about six feet or about two meters, etc.) has conventionally been challenging. Conventional systems utilize many receivers 18 and select the location of the receiver with the strongest RSSI as the asset location; however, this technique is expensive to implement due to the cost of the receivers 18. Further, using trilateration based on RSSIs from multiple receivers 18 using the known locations of the receivers 18 is unreliable due to variability in RSSI (e.g., due to multipath, interference, and/or other causes), especially if low-energy transmissions are used to and/or from the asset tags 14.

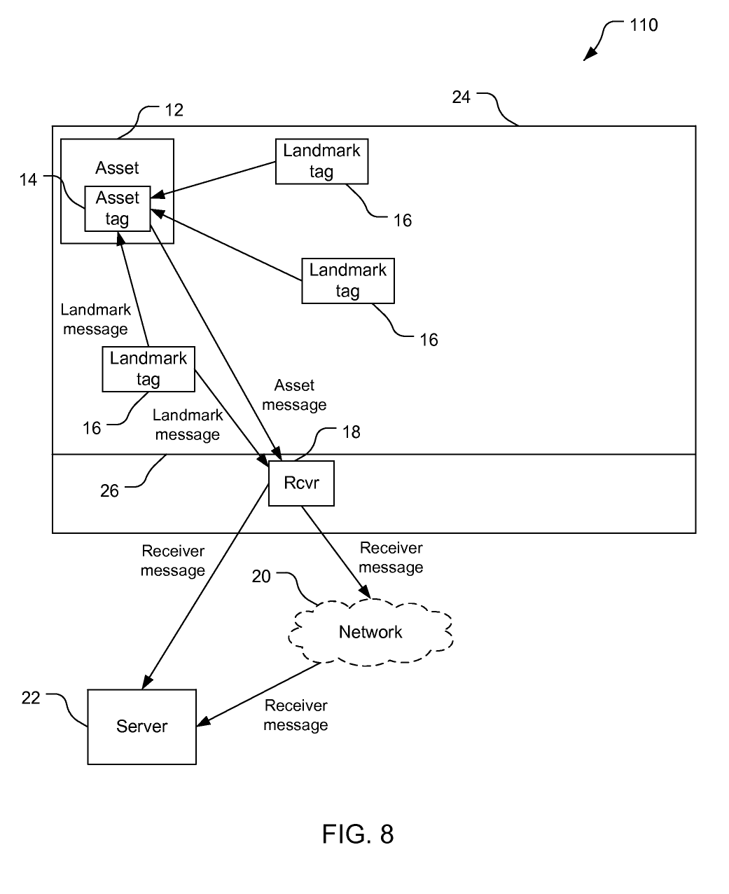

Referring to FIG. 8, an example of an asset tracking environment 110 includes features similar to those of the environment 10 shown in FIG. 1. In the environment 110, multiple landmark tags 16, each with a known location, may be disposed within communication range of the asset tag 14 and may be configured to communicate using short-range wireless communication signals. For instance, as shown in FIG. 8, the landmark tags 16 may be configured to transmit (e.g., broadcast) landmark messages to asset tags 14, receivers 18, and/or other entities in the environment 110. The landmark tags 16 are installed and positioned such that sufficient (e.g., at least three) landmark tags 16 are in communication range of any areas in which assets 12 are expected to be located in order to enable trilateration to determine the asset location. Also or alternatively, the location of a given asset 12 may be set to the location of the landmark tag 16 from which a landmark message is received by an asset tag 14 associated with the asset 12. Other techniques may also be used to determine a location of an asset 12.

The granularity of determined asset locations within the environment 110 may be improved by adding landmark tags 16. Further, the granularity of determined locations may be changed over time, for instance, by beginning with few landmark tags 16 and a corresponding coarse granularity and changing over time to have more landmark tags 16 and a correspondingly finer granularity, and/or by other means.

The asset tag 14 may include hardware and/or software components, subsystems, etc., herein referred to collectively as an asset message means (AMM), for producing an asset message including information from multiple landmark tags 16. The AMM may be implemented by the processor 30, the memory 32 including the software 34, the transceiver 38, and/or any other components of the asset tag 14. The AMM may be configured to receive landmark messages (each including a landmark ID) from the landmark tags 16, determine RSSIs corresponding to the messages, and compose an asset message that includes the landmark IDs and corresponding RSSIs. The AMM may send the asset message to the receiver 18, which in turn may forward some or all of the asset message to the server 22 in a receiver message. The receiver 18 may also determine an RSSI of the received asset message and provide this RSSI to the server 22. The receiver 18 may also forward information contained in the asset message, such as the RSSIs for the landmark messages, to the server 22.

The location of an asset 12 corresponding to an asset tag 14 may be determined based on the RSSIs of landmark messages and the locations of corresponding landmark tags 16, and may also be based on factors such as the RSSI of the asset message received by the receiver 18 and the known location of the receiver 18. The locations of the landmark tags 16 may be stored or determined in conjunction with determining the asset location. The location of the asset 12 may be determined by any of a variety of devices within the environment 110, such as the asset tag 14, the server 22, etc. In the example shown in FIG. 8, the location of the asset 12 is determined by the server 22. Proximity means, which may include one or more proximity algorithms, in the server 22 may be configured to use the known locations of the landmark tags 16 identified in the receiver message and the corresponding RSSIs to determine the asset location. The proximity means may do so by assigning the asset location as the location of the landmark tag 16 whose corresponding signal has the highest RSSI at the asset tag 14, by using trilateration (e.g., by converting the RSSIs into distances and determining the intersections of circles with radii of these distances centered at the corresponding known landmark tag locations), and/or by other techniques.

Also or alternatively, a tiered approach to asset location may be utilized as described below. In the tiered approach, the server 22, or another device determining the asset location, may be configured to determine a coarse location of the asset 12. For example, the server 22 may decide, or be directed, to determine a coarse location of the asset 12. To determine the coarse location, the server 22 may assign the location of the landmark tag 16 with the highest corresponding RSSI in the asset message from among landmark tags 16 that are designated as “coarse-location” landmark tags 16. Based on this designation, the server 22 may analyze only the RSSIs corresponding to landmark tags 16 that are designated as coarse-location landmark tags 16. Each landmark message may include an indication of whether the landmark tag 16 is a coarse-location landmark tag 16. In some implementations, more than two tiers of granularity may be provided, in which case the landmark tags 16 may correspond to respective tiers and transmit corresponding landmark messages that indicate the tier of the originating landmark tag 16. Thus, while various examples herein describe a two-tiered approach, configurations with more than two tiers may be used in a similar manner.

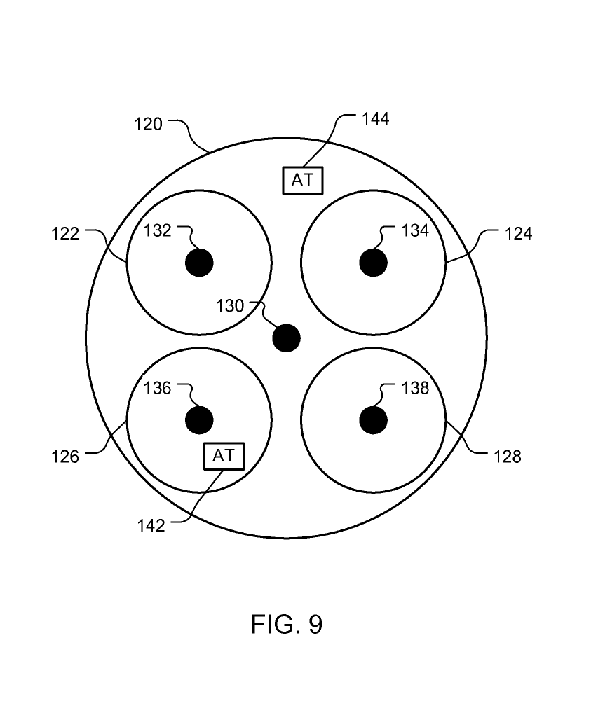

FIG. 9 illustrates example two-tier landmark tag coverage areas that are utilized as part of a two-tier asset tracking system as described above. Here, a landmark tag coverage area 120 corresponds to a tier-two landmark tag 130. Within the coverage area 120 are further coverage areas 122, 124, 126, 128, which respectively correspond to tier-one landmark tags 132, 134, 136, 138. The landmark tags 130, 132, 134, 136, 138 may be operated concurrently and/or independently. The transmission power of the tier-two landmark tag 130 may be stronger than the transmit powers of the tier-one landmark tags 132, 134, 136, 138, as generally shown in FIG. 9. Further, the transmit power of a landmark tag may be variable or fixed. As also shown in FIG. 9, a first asset tag (AT) 142 may be positioned in the coverage areas 120 and 126 while a second asset tag 144 may be positioned only in the coverage area 120.

Landmark messages from the landmark tags 130, 132, 134, 136, 138 are configured to indicate the tier of the corresponding landmark tag. Further, the asset messages from the asset tags 142, 142 are configured to indicate the landmark IDs, corresponding RSSIs, and corresponding tiers determined from received landmark messages. This information may, in turn, be used to determine the asset location via trilateration or other means. As another example, the asset tags 142, 144 may be configured such that the asset messages indicate a landmark tag ID and tier corresponding to landmark tags associated with signals with the highest RSSI in each tier, e.g., such that information for only one landmark tag in each tier is provided. Such messages may or may not include the corresponding RSSI information. As yet another example, the asset messages may include information for only one tier, e.g., the landmark IDs and corresponding RSSIs for the first tier of landmark tags 132, 134, 136, 138, or the tier-two landmark tag 130.

Due to size limitations, an asset message may not include landmark IDs for all received landmark messages. For example, if the asset message is limited to N landmark IDs, an asset message may include N−1 first-tier landmark IDs corresponding to the N−1 landmark messages with the highest corresponding RSSIs and one second-tier landmark ID. Asset messages with multiple landmark IDs may be configured to indicate landmark IDs in order of RSSI (e.g., strongest RSSI to weakest RSSI). Alternatively, the asset tags 142, 144 may be configured such that the asset messages only indicate a single landmark tag ID with a corresponding highest RSSI for a selected tier. For instance, a landmark tag ID of a first-tier landmark tag may be used if the first tier and a fine resolution setting is selected, or a landmark tag ID of a second-tier landmark tag may be used if the second tier and a coarse resolution setting is selected.

In the example shown in FIG. 9, if coarse asset location determination is used (such that the asset location is assigned to the location of the landmark tag with the highest corresponding RSSI), then both of the asset tags 142, 144 will be assigned the location of the coarse landmark tag 130. If fine asset location determination is used (such that the asset location is assigned to the location of the landmark tag with the highest corresponding RSSI and the finest tier with an available landmark message), then the first asset tag 142 will be assigned the location of the landmark tag 136 while the second asset tag 144 will be assigned the location of the landmark tag 130. Thus, the portion of the coverage area 120 not covered by one of the tier-one coverage areas 122, 124, 126, 128 is covered by the tier-two coverage area.

While a two-tier system of landmark tags is described above and shown in FIG. 9, any number of tiers could be used. For instance, an asset location system could support a larger number of tiers to enable multiple levels of resolution for asset location. Further, the transmit power of respective asset tags may be adjusted to provide high-resolution location estimates using a tiered system as described above. As an example, landmark tags in a lowest tier may transmit at a low power level such that only asset tags that are very close to the landmark tag can receive signals from the landmark tag. Other implementations are also possible.

Varying granularities of asset location as described above with respect to the environment 110 provide a variety of service and opportunities. For example, fewer receivers 18 may be used than with other systems, reducing cost of asset tracking. Additionally, asset tracking on a fine scale (e.g., tracking on a scale of less than six feet to uniquely identify a workstation or bench, among other uses) may be provided cost effectively. An indication, such as an alert or alarm, may also be provided if an asset tag 14 receives a landmark message from an unapproved landmark tag 16, such as a landmark tag 16 on a disapproved list or not on an approved list. Such an alert may indicate that an asset 12 is in a location in which the asset 12 is not approved to be, or an area that may result in undesired consequences, such as a temperature sensitive product being located in an area of high heat.

Asset Locating Using Relay Tags

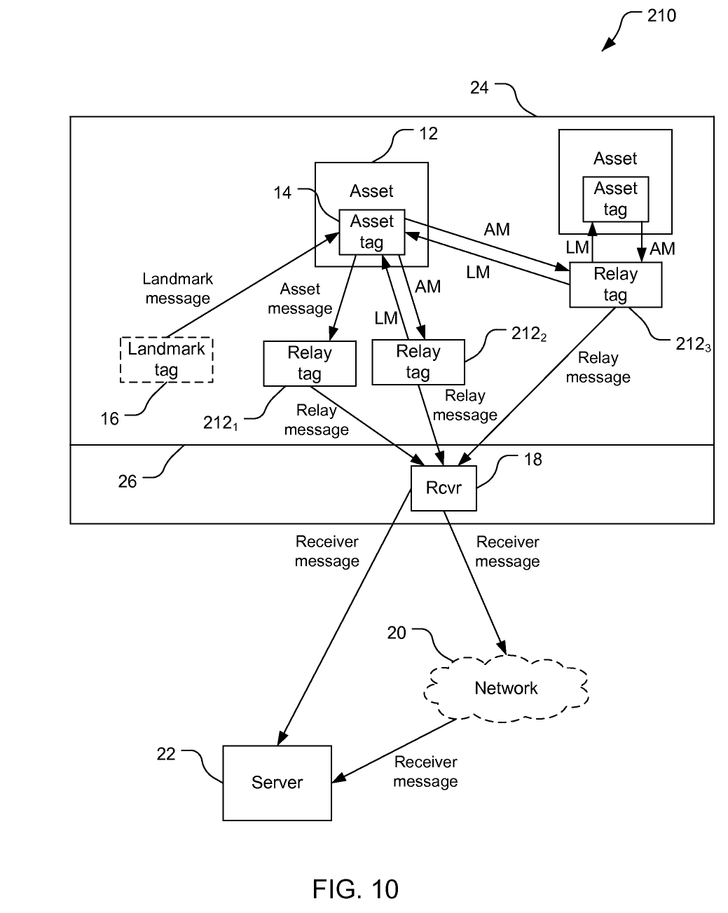

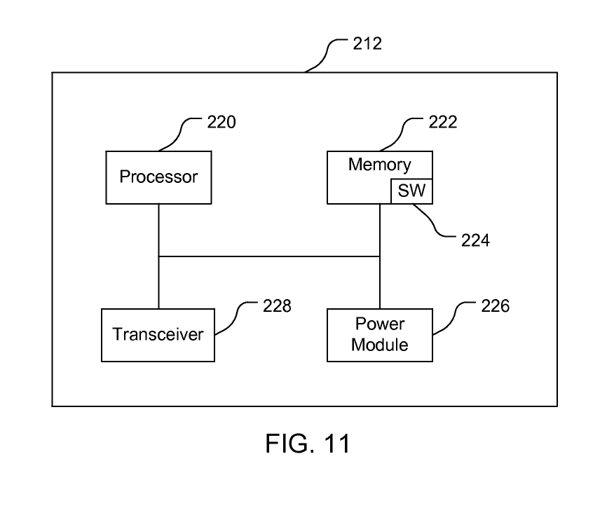

Referring next to FIG. 10, an example of an asset tracking environment 210 includes features similar to those of the environment 10 shown in FIG. 1. The environment 210 shown in FIG. 10 further includes multiple relay tags 212₁-212₃. Each of the relay tags 212 may include a landmark tag, although stand-alone relay tags that do not include respective landmark tags may also be used.

A single asset message may be sent from an asset tag 14 to the receiver 18 via multiple routes because the single asset message may be received and forwarded by multiple relay tags 212. Using these multiple relay messages, the server 22 can determine the location of an asset 12 by various techniques that include, but are not limited to, assigning the asset location to a location of the relay tag 212 with the strongest RSSI from the corresponding asset tag 14, using trilateration and/or RSSI values in connection with known relay tag and/or landmark tag locations, etc.

The environment 210 may provide desirable features that include, but are not necessarily limited to, the following. Battery life of an asset tag 14 may be increased compared to environments where the asset tag 14 would listen more often than in the environment 210. Reducing the number of receive periods, or eliminating receive periods, may increase battery life of the asset tag 14. Also, in an environment in which landmark tags 16 are used, an asset tag 14 may not attempt to receive landmark messages from multiple landmark tags 16, but instead may be configured to receive a single landmark message indicating that relay tags 212 are present. As a result, the receive period may be shorter than in other environments, further reducing battery drain and increasing battery life. Further, by reducing or eliminating landmark messages, radio frequency (RF) transmissions in the environment 210 are reduced compared to environments with more landmark tags. In the environment 210, for example, instead of landmark messages being sent frequently by multiple landmark tags, landmark messages may not be sent, and only infrequent (e.g., four times daily, etc.) asset messages may sent by the asset tags 12. These asset messages may then be forwarded by the relay tags 212 in relay messages. Transmissions by the asset tags 14 may also be scheduled such that interference is reduced, for instance, by scheduling asset tag transmissions to occur during times when other transmissions are not occurring. Further, asset tag transmission power may be reduced compared to environments without relay tags 212 because the asset messages are not sent directly to and need not reach the receiver 18. For similar reasons, the range of the environment 210, defined as the area over which asset tags 14 may communicate with the receiver 18, may be greater than that of environments without relay tags 212. Further, landmark tags 16 may be used in the environment 210 to provide screen room functionality as discussed above. Server processing may also be reduced, for instance, by filtering asset messages and/or relay messages such that the server 22 avoids receiving and processing some messages.

Referring also to FIG. 11, an example one of the relay tags 212 includes a processor 220, memory 222 that includes software 224, a power module 226, and a transceiver 228. The power module 226 of the relay tag 212 may be configured to connect to grid power and/or other power sources (e.g., a battery, etc.).

The relay tag 212 may be configured to scan/listen continuously for asset messages. The transceiver 228 may include one or more appropriate antennas and be configured to receive asset messages from and/or otherwise communicate with the asset tags 14 and to transmit relay messages to and/or otherwise communicate with the receiver 18. The processor 220 may be an intelligent hardware device, e.g., a central processing unit (CPU) such as those made by ARM®, Intel® Corporation, or AMD®, a microcontroller, an application specific integrated circuit (ASIC), etc. The processor 220 could also or alternatively comprise multiple separate physical entities that can be distributed in the relay tag 212.

The memory 222 may be a non-transitory processor-readable storage medium, and may include random access memory (RAM) and read-only memory (ROM). The memory 222 may be configured to store the software 224, which is processor-readable, processor-executable software code containing processor-readable instructions that are configured to, when executed, cause the processor 220 to perform various functions described herein. Alternatively, the software 224 may not be directly executable by the processor 220 but configured to cause the processor 220, e.g., when compiled and executed, to perform the functions.

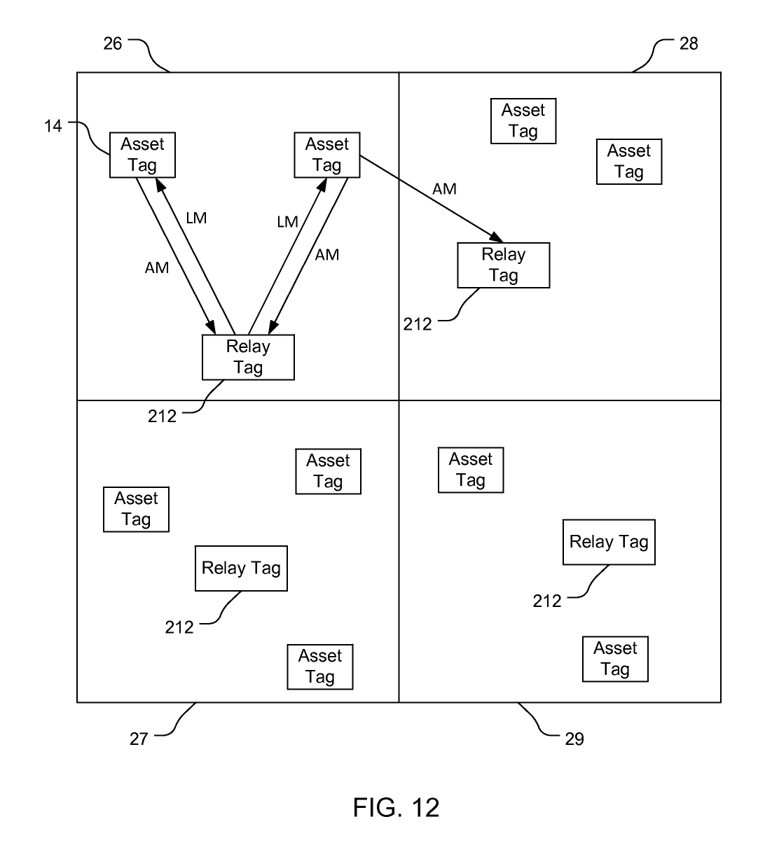

Referring to the example environments shown in FIGS. 10 and 12, here the relay tags 212 have known locations and are placed to provide a desired granularity of asset location resolution. For example, respective ones of the relay tags 212 may be placed in each of regions 26-29, and/or on desks, workstations/benches, etc. to provide corresponding location granularity. For example, here the regions 26-29 are rooms and thus provide room granularity. This level of granularity and/or other levels of granularity (e.g., desk granularity, workstation/bench granularity, etc.) may be provided depending upon the level of granularity of placement of the relay tags 212.

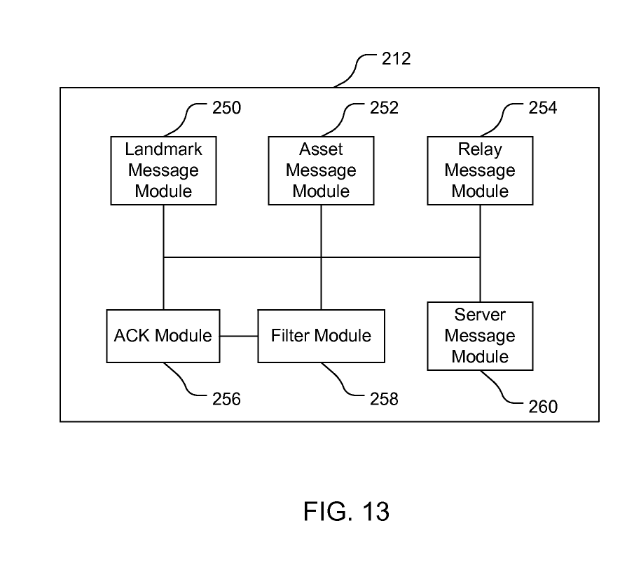

Referring to FIG. 13, an example one of the relay tags 212 includes a landmark message module 250, an asset message module 252, a relay message module 254, an ACK (acknowledgement) module 256, a filter module 258, and a server message module 260. The modules 250, 252, 254, 256, 258, 260 are functional modules implemented by one or more of the processor 220, the software 224 stored in the memory 222, and/or the transceiver 228 (e.g., via a WPAN communication module and/or other communication module). Thus, reference to any of the modules 250, 252, 254, 256, 258, 260 performing or being configured to perform a function is shorthand for one or more of the processor 220 (in accordance with the software 224 (and/or firmware and/or hardware of the processor 220)) and/or the transceiver 228 being configured to perform the function. Similarly, reference to the processor 220 or the relay tag 212 performing a function such as message receiving, message producing, filtering, and/or another function, is equivalent to the landmark message module 250, the asset message module 252, the relay message module 254, the ACK module 256, the filter module 258, and/or the server message module 260, respectively as appropriate, performing the function.

The landmark message (LM) module 250 operates as means for sending a landmark message and may be configured to produce and send landmark messages to the asset tags 14. The landmark message module 250 may be configured to send broadcast landmark messages (LMs) to indicate the presence of a relay tag in the vicinity of the landmark tag, for instance, within radio range of asset tags 14 receiving the landmark message. That is, the LM module 250 may wirelessly broadcast the LMs using a low-power, short-range, wireless protocol and/or another suitable protocol. The LMs from the landmark tags of the relay tags 212 in the environment 210 may provide an indication that the environment includes relay tags 212 while LMs from stand-alone landmark tags 16 in environments without relay tags 212 do not provide this indication, and thus indicate that the environment does not have relay tags 212. The asset tags 14 may respond to the LMs by eliminating or reducing future listen periods, adjusting a sleep interval or a receive interval, and/or performing other suitable actions. The asset tag 14 may be configured to analyze the LMs and to respond to the environment appropriately. If the environment does not have relay tags 212, the asset tag 14 may continue to wake up and listen for LMs; alternatively, if the environment has relay tags 212, the asset tag 14 may either reduce the frequency of future listen periods (e.g., listening once a day instead of four times a day, etc.) or eliminate future listen periods. Further, if screen room or other location-based transmissions are not an issue, then the asset tag 14 may be configured not to listen for LMs.

The LM module 250 may be configured to produce LMs using information provided by the server 22. For example, the LM module 250 may include in a broadcast LM an indication for any asset tag 14 receiving the LM to increase (or decrease) the transmission power used by the asset tag 14 to send its asset message (AM). Thus, the LM module 250 may implement regional power control by using a broadcast message to cause receiving asset tags 14 in a region proximate to the relay tag 212 in a radio transmission sense, i.e., within communication range of the relay tag 212 using short-range, low-power wireless communication, to increase or decrease AM transmission power. The indication in the LM could be to set transmission power to a certain, indicated power, or simply to increase transmission power or to decrease transmission power, regardless of present transmission power. Simple indications to increase transmission power may be indications to increase the transmission power by one incremental amount up to a high-threshold (or maximum) transmission power. Simple indications to decrease transmission power may be indications to decrease the transmission power by one incremental amount down to a low-threshold (or minimum) transmission power.

The asset message module 252 of each of the relay tags 212 may operate as means for receiving an AM and/or means for determining RSSI as follows. The asset message module may 252 be configured to scan for AMs and determine corresponding RSSIs of the AMs at the relay tags 212. The asset message module 252 may determine the RSSI of each received AM and provide the RSSI values along with indications of the corresponding asset tags 14 for those RSSI values to the relay message (RM) module 254. The asset message module 252 may also extract information contained in the AMs and provide this information to the RM module 254 for inclusion in relay messages (RMs).

The relay message module 254 may operate as means for producing a relay message and/or means for sending the relay message as follows. The relay message module 254 may be configured to produce the RMs and to send the RMs to the receiver 18. The RM module 254 may format the RMs for transmission to the receiver 18, in either a similar format or a different format from the AMs. The RM module 254 may use portions of the substance of the AMs and/or RSSI information of the AMs as provided by the AM module 252 to form the RMs.

The acknowledgement (ACK) module 256 may operate as means for sending an ACK as follows. The ACK module 256 may be configured to provide an ACK in response to receiving an AM. For instance, the ACK module 256 may determine that the relay tag 212 has received an AM and, in response, broadcast the ACK indicating receipt of the AM. The ACK may include information identifying a specific asset tag 14 from which the AM is received. For example, the ACK signal may include an asset tag identifier extracted from the AM and/or other identifying information of the asset tag. The ACK may also provide information as to the AM to which the ACK corresponds, which may include an asset message number, a time of receipt of the AM, and/or other information. The asset tag 14 may also be configured to listen for the ACK in response to the AM and to respond to the absence of a received ACK by boosting the transmission power relative to the AM for which no ACK is received for the next AM transmitted by the asset tag 14. The absence of an ACK, as used here, may be either the absence of an ACK received from any relay tag 212 or the absence of an ACK received from one or more specific relay tags 212. The ACK may be broadcast and/or unicast. If broadcast, the ACK may include an indication for each asset tag 14 from which an AM was received.

The filter module 258 may operate as means for filtering as follows. The filter module 258 may be configured to filter AMs received by the relay tag 212. For instance, the relay tag 212 may analyze a received AM and determine whether to forward the AM or any of its content in an RM. The relay tag 212 may discard a received AM entirely, or alternatively it may decide to use only a portion of the information from the AM in a corresponding RM. The relay tag 212 may apply various criteria in determining whether to discard or disregard some or all of the content of a received AM. For example, the relay tag 212 may determine whether a received AM is presently of importance, and discard or disregard some or all of the AM if the AM is presently not of importance. Importance of an AM may be determined based on various factors such as, for example, indications by the receiver 18 and/or the server 22, time of day, location of the asset tag 14 sending the AM, an RSSI of the AM, etc.

While not shown in the context of the receiver 18, the receiver 18 may also include a filter module that operates similar to the filter module 258. In this implementation, the receiver, via an associated filter module, may filter RMs and, in response to the filtering, selectively forward RMs, selectively discard or disregard RMs, or selectively discard or disregard portions of the RMs. The RMs may be filtered based on various criteria, such as whether an RM is presently important and/or other criteria. Importance of an RM may be determined based on an indication by the server (e.g., that the RM originates from a presently-important relay), a region of origin, a time of day, etc.

The server message module 260 may operate as means for receiving and processing server messages as follows. The server message module 260 may be configured to receive and process server messages and provide appropriate information to the landmark message module 250. The server message module 260 may receive and analyze server messages from the server 22 and, in response, provide appropriate information to the landmark message module 250 for use in producing LMs. For example, the server message module 260 may instruct the landmark message module to send an AM message transmit power increase instruction or an AM message transmit power decrease instruction, to include an indication in an LM that one or more relay tags 212 are present, etc.

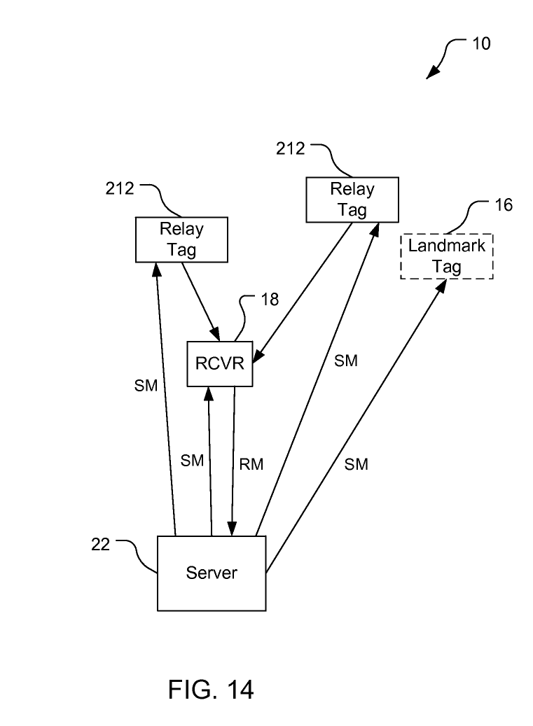

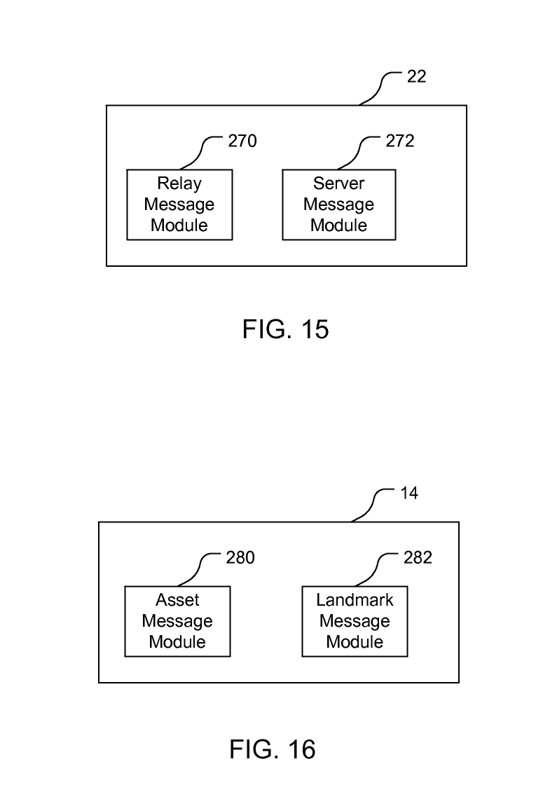

Referring to FIGS. 14-15, with further reference to FIGS. 5 and 10, a server 22 in an example asset tracking environment 10 may be configured to process relay messages (RMs) from the receiver 18 and to produce and provide server messages (SMs) to the receiver 18, the relay tags 212, and the landmark tags 16 (if any). As shown in FIG. 15, an example of a server 22 includes a relay message module 270 and a server message module 272. The modules 270, 272 are functional modules which may be implemented by one or more of the processor 90, the software 94 stored in the memory 92, and/or the transceiver 96. Thus, reference to either of the modules 270, 272 performing or being configured to perform a function is shorthand for one or more of the processor 90 (in accordance with the software 94 (and/or firmware and/or hardware of the processor 90)) and/or the transceiver 96 performing or being configured to perform the function. Similarly, reference to the processor 90 or the server 22 performing a function such as message receiving, message producing, and/or another function, is equivalent to the relay message module 270 and/or the server message module 272, respectively as appropriate, performing the function.

The relay message module 270 may operate as means for receiving and analyzing an RM as follows. The relay message module 270 may be configured to receive and analyze RMs. The relay message module 270 may determine the RSSI for an AM and the known locations of the relay tags 212 at which the AM was received. The relay message module 270 may use this information to perform trilateration to determine the location of the asset tag 14. Alternatively, the relay message module 270 may use the known location of a relay tag 212 that receives an AM as the location of the asset tag 14 that sent the AM. Still further techniques may be used by the relay message module 270 to determine the location of an asset tag 14.

The server message module 272 may operate as means for sending a server message as follows. The server message module 272 may indicate in an SM for a receiving relay tag 212 or landmark tag 16 to send a broadcast LM. The broadcast LM may, in turn, instruct each asset tag 14 receiving the LM to adjust its asset message transmission power to provide regional power control for AM transmission, among other functions. As an example, the SM module 272 may instruct transmission of an LM to reduce transmission power for a region adjacent to a region where a desired AM is not being received well (at a poor signal-to-noise ratio (SNR), etc.). This may help reduce noise in the desired AM and thus help enable use of the desired AM. As another example, the SM module 272 may instruct transmission of an LM to instruct each asset tag 14 receiving the LM to boost (increase) the transmission power for AMs, for instance, where AMs are not being received by a relay 212. As another example, the SM module 272 may instruct transmission of an LM to instruct each asset tag 14 receiving the LM to decrease the transmission power for AMs, for instance, where AMs are being received with strong RSSI (e.g., RSSI above a threshold, etc.) and the lower transmission powers would not likely inhibit reception of the AMs with sufficient power to understand and use the content of the AMs. As yet another example, the SM module 272 may cause one or more relay tags 212 (and/or one or more landmark tags 16) that neighbor a region of high asset tag transmission power to send LMs that instruct a decrease in AM transmission power. Subsequently, asset tags in the region of high asset tag transmission power may also be instructed to lower AM transmission power.

Referring to FIG. 16, an example of an asset tag 14 includes an asset message module 280 and a landmark message module 282. The modules 280, 282 are functional modules implemented by one or more of the processor 30, the software 34 stored in the memory 32, the battery 36, and/or the transceiver 38. Thus, reference to either of the modules 280, 282 performing or being configured to perform a function is shorthand for one or more of the processor 30 (in accordance with the software 34 (and/or firmware and/or hardware of the processor 30)) and/or the transceiver 38 performing or being configured to perform the function. Similarly, reference to the processor 30 or the asset tag 14 performing a function such as message receiving, message producing, message transmitting, and/or another function, is equivalent to at least one of the asset message module 280 and/or the landmark message module 282, respectively as appropriate, performing the function.

The asset message module 280 may operate as means for sending an asset message as follows. The asset message module 280 may be configured to produce and send AMs from the asset tag 14. Further, the AM module 280 may affect transmission power of AMs sent from the asset tag 14 based on LMs received by the asset tag 14. For example, the AM module 280 may set an AM transmission power to a first power in response to receiving an LM indicating presence of a relay tag 212, or to a second power that is higher than the first power in response to receiving an LM not indicating presence of a relay tag 212 in communication range of the asset tag 14. As another example, the AM module 280 may reduce a transmit power setting in response to a received broadcast LM indicating to reduce AM transmit power. The AM module 280 may reduce a setting for the AM transmit power by an incremental amount (as long as the present setting is above a minimum AM transmit power threshold), may set the AM transmit power to an amount indicated by the LM, etc. As another example, the AM module 280 may reduce a transmit power setting (e.g., by an incremental amount, to a predetermined value regardless of a present transmit power setting, etc.) in response to a received LM indicating presence of one or more relay tags 212. As another example, the AM module 280 may increase the AM transmit power setting, or set the AM transmit power setting to a predetermined value, in response to a received LM indicating either an instructed increase in AM transmit power or absence of one or more relay tags 212 (e.g., by not indicating presence of one or more of the relay tags 212).

The landmark message module 282 may operate as means for receiving and analyzing a landmark message as follows. The landmark message module 282 may be configured to receive and analyze incoming LMs and take appropriate action. For instance, the LM module 282 may provide information from an LM to the AM module 280 for use in an AM. The LM module 282 may set a sleep time of the asset tag 14 based on information in the LM. For example, the LM module 282 may set an amount of time that the asset tag 14 sleeps between periods of listening for an LM to a first amount of time in response to receiving an LM indicating presence of a relay tag 212 or to a second amount of time that is shorter than the second amount of time in response to receiving an LM not indicating presence of at least one relay tag 212 in communication range of the asset tag 14.

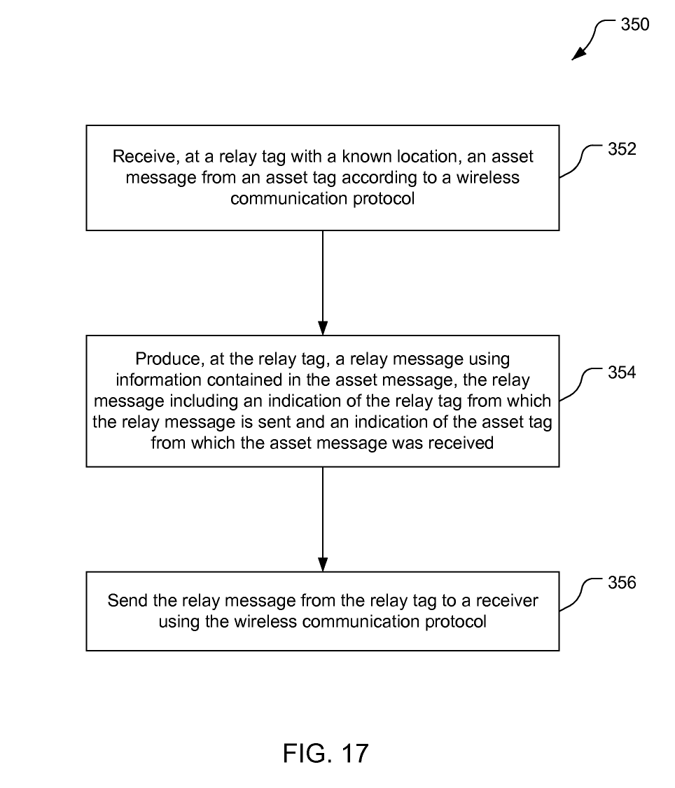

Referring to FIG. 17, with further reference to FIGS. 1 and 10-13, a process 350 of providing information for asset location via a relay tag 212 includes the stages shown. The process 350 is, however, an example only and not limiting. The process 350 can be altered, e.g., by having stages added, removed, rearranged, combined, performed concurrently, and/or having single stages split into multiple stages.

At stage 352, an asset message is received at a relay tag 212 with a known location from an asset tag 14 according to a wireless communication protocol. The protocol used at stage 352 could include, but is not limited to, WPAN protocols such as the Bluetooth® protocol or the BLE protocol, other low-power and/or short-range protocols, and/or any other wireless communication protocol, whether currently existing or existing in the future. As an example, an asset tag 14 may send an asset message using a transceiver 38. A relay tag 212 may then receive the asset message using a corresponding transceiver 228 at the relay tag 212.

At stage 354, the relay tag 212 produces a relay message using information contained in the asset message received at stage 352. The relay message includes, among other possible information, an indication of the relay tag 212 from which the relay message is sent and an indication of the asset tag 14 from which the asset message was received. As described above, an asset message module 252 of the relay tag 212 may analyze the received asset message and obtain an identity of the asset tag 14 that sent the asset message, among other information. A relay message module 254 of the relay tag 212 may then use at least some of the obtained information from the asset message to produce the relay message.

At stage 356, the relay tag sends the relay message generated at stage 354 to a receiver 18 using the wireless communication protocol used at stage 352 (or a different protocol). The receiver may, in turn, forward content of the relay message toward a server 22 in a relay message.

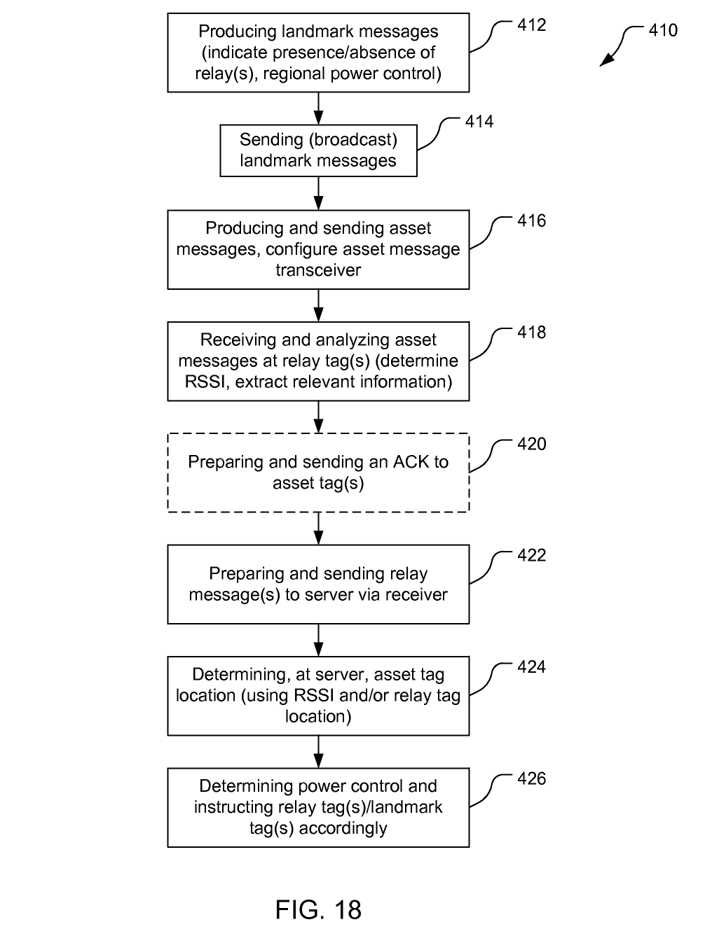

Referring to FIG. 18, with further reference to FIGS. 1 and 10-16, a process 410 of locating an asset includes the stages shown. The process 410 is, however, an example only and not limiting. The process 410 can be altered, e.g., by having stages added, removed, rearranged, combined, performed concurrently, and/or having single stages split into multiple stages. For example, stage 420 may be eliminated in some implementations.

At stage 412, landmark messages are produced by a relay tag 212 and/or a landmark tag 16. Here, a LM module 250 of either a relay tag 212 or a landmark tag 16 prepares the landmark message for broadcast. To produce the LM, the LM module 250 may retrieve the LM from a memory 222 and/or generate the LM using instructions in one or more server messages received from a server 22. The LM may indicate the presence or absence of one or more relay tags 212; however, specific relay tags 212 may not be identified in some implementations. An indication of the presence of one or more relay tags 212 may inform the asset tag 14 that it may transmit with lower power than that which would be used if no relay tag 212 is present. The LM may further provide a power control instruction to either reduce or increase AM transmit power. A power control instruction may instruct incremental power adjustment, may indicate an explicit power value to be used by the asset tag 14 or an implicit power value (e.g., as a power label corresponding to a power setting stored in a memory 32 of the asset tag 14), or facilitate power control by other means.

At stage 414, the LM produced at stage 412 is sent by the LM module 250 of the relay tag 212 and/or landmark tag 16, e.g., in a broadcast transmission or another suitable transmission. For instance, the LM module 250 may send the LM message by broadcasting the LM message using a transceiver 58 or 228 for receipt by any asset tag 14 within communication distance. The LM may subsequently be received by one or more of the asset tags 14.

At stage 416, each of the asset tags 14 produces an AM and transmits the AM in response to receiving the LM. The AM may be produced and/or sent using information from the LM, or may be produced and sent without using content of the LM. Additionally, an asset tag 14 may configure its transceiver 38 based on information in the LM in various manners. For instance, the asset tag 14 may set a sleep time based upon whether the LM indicates presence of a relay tag 212 within communication range of the asset tag 14. As another example, an AM module 280 of the asset tag 14 may set a transmit power for AMs based on content (or the absence of content) in the LM.

At stage 418, the AMs sent at stage 416 are received and analyzed at one or more relay tags 212. For instance, a relay tag 212 may determine an RSSI for a received AM and extract relevant information from the AM, such as an identity of the asset tag 14 from which the AM is received.

At stage 420, respective ones of the relay tags 212 prepare and send an ACK corresponding to the AMs received at stage 418 to one or more asset tags 14 from which the AMs are received. This stage is optional and may be omitted in some implementations. If performed, the relay tag 212 may configure the ACK to indicate that AMs were received from one or more particular asset tags 14. An ACK may indicate a single asset tag 14 and be sent in a unicast transmission directed to that asset tag 14 and/or a broadcast transmission, or alternatively the ACK may indicate multiple asset tags 14 and be sent in a multicast or broadcast transmission to those asset tags 14.

At stage 422, one or more relay messages are prepared by the relay tags 212 and sent to a server 22 via a receiver 18. The relay tags 212 may prepare relay messages by filtering received AMs, forwarding AMs as-is, extracting information from one or more AMs to form the RM, etc. The relay tags 212 may send the relay messages to the receiver 18 using the same wireless communication protocol used to send the AM to the relay tag 212 at stage 416 and/or a different protocol.

At stage 424, the server 22 uses one or more RMs sent at stage 422 to determine the location of an asset tag 14. For example, the server 22 may use a single RM indicating a relay tag 212 at which an AM was received to set the location of the asset tag 14 to the known location of the relay tag 212. As another example, the server 22 may receive RMs from multiple relay tags 212, each indicating a corresponding RSSI of a single AM from a single asset tag 14. The server 22 may use these RSSIs and the known locations of the relay tags 212 sending the RMs to perform trilateration to determine the location of the asset tag 14. Other techniques, as well as combinations of the listed techniques and/or other techniques, may also be used.

At stage 426, the server 22 determines power control parameters and instructs one or more relay tags 212 and/or landmark tags 16 accordingly. Here, the server 22 may determine any appropriate AM transmit power adjustments and prepare and send one or more SMs to the corresponding relay tag(s) 212 and/or landmark tag(s) 16. The SMs may direct the relay tag(s) 212 and/or landmark tag(s) 16 to send LMs instructing receiving asset tags 14 to adjust their AM transmit powers by reducing or increasing power incrementally, setting power to a specified level, etc.

Fine-Granularity Information Dissemination

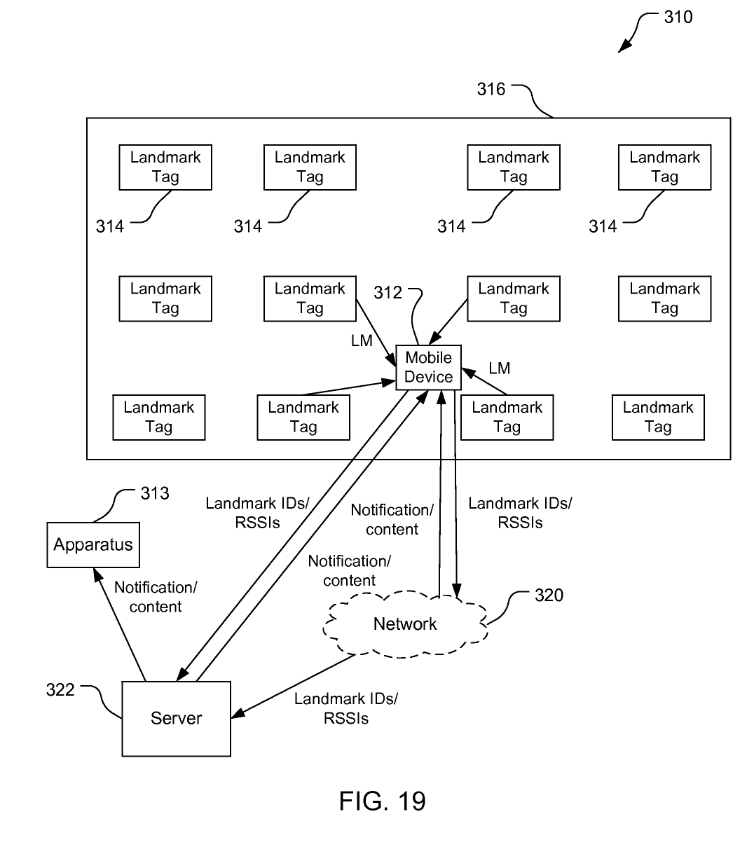

Referring to FIG. 19, an example of an information dissemination system 310 includes a mobile device 312, landmark tags 314 positioned within a building 316, a network 320, and a server 322. The number of landmark tags 314 used, and/or the positions of the landmark tags 314, may be selected to provide a desired location resolution. In the example shown in FIG. 19, 12 landmark tags 314 are provided in a rectangular grid formation. Other numbers and/or configurations of landmark tags 314 could also be used. The landmark tags 314 may include components similar to the landmark tags 16 shown in FIGS. 1 and 3, and the server 322 may include components similar to the server 22 shown in FIGS. 1 and 5. As with the landmark tags 16, the landmark tags 314 may use a short-range, low-power wireless communication protocol and/or any other protocol. The transmission power of the landmark tags 314 may be adjusted to provide desired range(s).

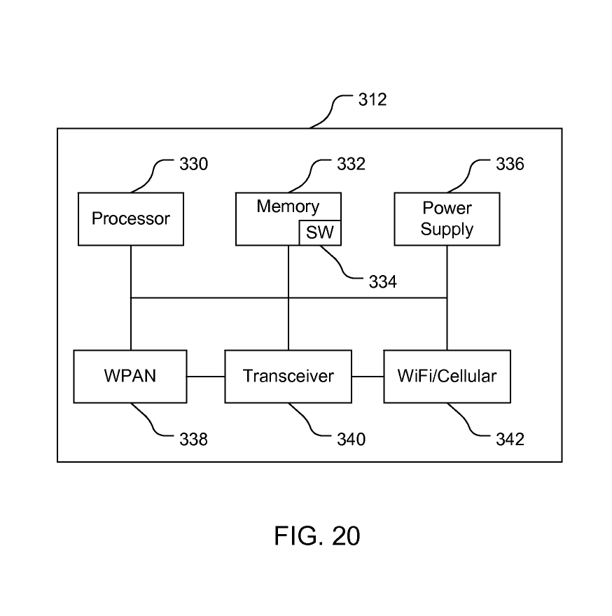

Referring also to FIG. 20, an example of a mobile device 312 includes a processor 330, a memory 332 including software 334, a power supply 336, a WPAN module 338, a transceiver 340, and a WiFi/Cellular module 342. The WPAN module 338 may be configured to communicate using one or more WPAN protocols with other nearby communication devices. The Wi-Fi/Cellular module 342 may be configured to communicate using Wi-Fi and/or cellular (e.g., 3G, 4G, etc.) protocols with access points (not shown), the network 320, and the server 322.

The mobile device 312 may be configured to collect and forward landmark tag information. For instance, the mobile device 312 may scan for the landmark messages (LMs) from the landmark tags 314 and forward/send landmark identities (landmark IDs) and RSSIs corresponding to received LMs to the server 22. The server 22 may then use stored locations of the landmark tags 314 corresponding to the noted landmark IDs, the corresponding RSSIs, and/or other information to determine a location of the mobile device 312. In response to determining the mobile device's location, the server 22 may send appropriate notification(s)/content for that location to the mobile device 312 in accordance with any preference(s) and/or permission(s) associated with the mobile device 312. For example, a user of the mobile device 312 may provide a request and/or be granted access/permission for some information, and/or the user of the mobile device 312 may block certain information.

Content may be published/pushed to the server 22 in a variety of ways. For instance, a user of the mobile device 312 may use an application to generate content and deliver the content to the server 322. The mobile device 312 may also provide landmark IDs and corresponding RSSIs to the server 322. The server 322 may then determine the location of the mobile device 312 and add content (or notification(s)) for the determined location. Alternatively, a user may interact with an application, such as a web site accessed by the user through a web interface and/or another application, to produce content.

The server 22 may be configured to provide content to appropriate devices based on location associated with the content. The server 22 may send content corresponding to a location to devices associated with the location, e.g., to devices in that location and/or that have requested content related to that location.

The system 310 may also provide location-aware content. A user of the mobile device 312 or another apparatus 313 may request (or subscribe to) information related to a particular region. In response to content being produced for the particular region, the server 322 may send the content to the mobile device 312 or the apparatus 313. The request for information related to a region may take a variety of forms. These could include, but are not limited to, the user interacting with an application to select an option to receive such information, an automatic process initiated in response to the mobile device 312 being located in the region, etc. Thus, the present location of the mobile device 312 and/or any subscription setting may play a role in whether the mobile device 312 and/or the apparatus 313 is sent content. For example, a user of the apparatus 313 may request to receive notifications for the region of the mobile device 312 regardless of the present location of the apparatus 313. Also or alternatively, the user of the mobile device 312 may request to receive content for a region when the mobile device 312 is proximate to (e.g., in the same building as, within N meters of, etc.) the region, and/or when the mobile device 312 is in the region. The content may be sent to the mobile device 312 or the apparatus 313 in a variety of ways, such as via email, short message service (SMS), instant messaging (IM), etc. The granularity of location related to content (for generated content and/or pushed content) may be very fine and may be a function of the granularity of placement of landmark tags 314 and/or a resolution capable using the landmark tags 314 as based on landmark tag transmit power or other factors.

The system 310 may provide real-time, location-aware content notification. In doing so, the system 310 can provide information in a cost-efficient way, with fine-granular position resolution, and in an easy-to-deploy manner.

Location-based content delivery using the system 310 can be applied to a variety of applications. For example, location-based social media may be enabled such that, e.g., social media content may be shared only with mobile devices in proximity to the mobile device providing the content. Notices may be provided regarding malfunctioning or inoperable devices. For instance, workers near a copier may be notified that the copier is out of order, persons near a break room may be notified that the coffee machine in that break room is empty or not working, etc. Notices may also be provided with respect to time-critical information. For instance, workers near a conference room may be notified that free food is available in the conference room. As another example, a list of equipment assigned to a workstation may be provided to a mobile device near that workstation, and/or lists of equipment assigned to each workstation in a room may be provided to a requesting mobile device in the room. As a further example, a description of an object of interest (e.g., a piece of art, a museum exhibit, etc.) may be provided to mobile devices proximate to the object of interest. Still further, information regarding a region may be provided to a device outside that region. For instance, information regarding malfunctioning equipment in a region may be sent to a maintenance technician assigned to the region.

Further Considerations

As used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C), or combinations with more than one feature (e.g., AA, AAB, ABBC, etc.).

As used herein, including in the claims, unless otherwise stated, a statement that a function or operation is “based on” an item or condition means that the function or operation is based on the stated item or condition and may be based on one or more items and/or conditions in addition to the stated item or condition.

A wireless communication network does not have all communications transmitted wirelessly, but is configured to have at least some communications transmitted wirelessly.

Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Further, more than one invention may be disclosed.

Substantial variations to described configurations may be made in accordance with specific requirements. For example, customized hardware might also be used, and/or particular elements might be implemented in hardware, software (including portable software, such as applets, etc.), or both. Further, connection to other computing devices such as network input/output devices may be employed.

Common forms of physical and/or tangible computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, EPROM, a FLASH-EPROM, any other memory chip or cartridge, a carrier wave as described hereinafter, or any other medium from which a computer can read instructions and/or code.

The methods, systems, and devices discussed above are examples. Various configurations may omit, substitute, or add various procedures or components as appropriate. For instance, in alternative configurations, the methods may be performed in an order different from that described, and that various steps may be added, omitted, or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations provides a description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional stages or functions not included in the figure. Furthermore, examples of the methods may be implemented by hardware, software, firmware, middleware, microcode, hardware description languages, or any combination thereof. When implemented in software, firmware, middleware, or microcode, the program code or code segments to perform the tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of operations may be undertaken before, during, or after the above elements are considered. Accordingly, the above description does not bound the scope of the claims.

What is claimed is:

1. A method for asset location via a relay tag, the method comprising:
receiving, at the relay tag, an asset message from an asset tag according to a wireless communication protocol, wherein the relay tag has a known location;
producing, at the relay tag, a relay message using information contained in the asset message, wherein the relay message includes an indication of the relay tag from which the relay message is sent and an indication of the asset tag from which the asset message was received; and
sending the relay message from the relay tag to a receiver using the wireless communication protocol.

2. The method of claim 1 further comprising wirelessly sending a landmark message from the relay tag or a landmark tag to the asset tag, wherein the landmark message indicates presence of at least one relay tag to relay the asset message, and wherein the landmark message is broadcast for receipt by a plurality of asset tags.

3. The method of claim 2 further comprising:
receiving, at the asset tag, the landmark message; and
setting, at the asset tag, an amount of time that the asset tag sleeps between periods of listening for landmark messages to a first amount of time;
wherein the first amount of time is longer than a second amount of time for which the asset tag sleeps between listening for landmark messages, the second amount of time being set by the asset tag if no relay tags are indicated to be present within communication range of the asset tag.

4. The method of claim 2 wherein the asset tag intermittently listens for the landmark message during listen periods of a listen duration, and wherein the asset tag responds to receiving the landmark message by decreasing the listen duration.

5. The method of claim 2 further comprising:
receiving, at the asset tag, the landmark message; and
setting, at the asset tag, an asset message transmission power to a first power;
wherein the first power is lower than a second power, the second power being set by the asset tag for the asset message transmission power if no relay tags are indicated to be present within communication range of the asset tag.

6. The method of claim 1 wherein:
the receiving comprises receiving the asset message at a plurality of relay tags with known locations; and
the method further comprises:
determining a received signal strength indication (RSSI) for the asset message at each of the plurality of relay tags;
generating, at the relay tags, respective relay messages, the relay messages including indications of the RSSIs determined for the asset tag by the respective relay tags; and
sending the relay messages from the relay tags to the receiver using the wireless communication protocol.

7. The method of claim 1 wherein:
the asset message is a first asset message; and
the method further comprises:
receiving, at the relay tag, a second asset message;
analyzing the first asset message and the second asset message based on at least one criterion;
disregarding at least a portion of the second asset message in response to the analyzing; and
refraining from transmitting a relay message from the relay tag to the receiver corresponding to at least one disregarded portion of the second asset message.

8. The method of claim 1 further comprising:
sleeping, at the asset tag, for a sleep duration;
listening, at the asset tag, for a landmark message during a listen period; and
in response to the landmark message not being received during the listen period, repeating the sleeping for the sleep duration without transmitting the asset message from the asset tag.

9. The method of claim 1 wherein the wireless communication protocol is a wireless personal area network (WPAN) protocol.

10. The method of claim 1 wherein the wireless communication protocol is a low-power wireless communication protocol.

11. The method of claim 1 further comprising forwarding content of the relay message from the receiver to a server.

12. A non-transitory processor-readable storage medium associated with a relay tag, the storage medium comprising processor-readable instructions configured to cause a processor of the relay tag to:
receive an asset message from an asset tag according to a wireless communication protocol;
produce a relay message using information contained in the asset message, wherein the relay message includes an indication of the relay tag from which the relay message is sent and an indication of the asset tag from which the asset message was received; and
send the relay message to a receiver using the wireless communication protocol.

13. The storage medium of claim 12 further comprising instructions configured to cause the processor of the relay tag to broadcast a landmark message for receipt by a plurality of asset tags, wherein the landmark message indicates presence of at least one relay tag to relay the asset message.

14. The storage medium of claim 12 further comprising instructions configured to cause the processor of the relay tag to:
determine a received signal strength indication (RSSI) for the asset message; and
include an indication of the RSSI determined for the asset message in the relay message.

15. The storage medium of claim 12 wherein:
the asset message is a first asset message;
the instructions configured to cause the processor of the relay tag to receive the asset message are configured to cause the processor of the relay tag to receive a second asset message; and
the storage medium further comprises instructions configured to cause the processor of the relay tag to:
analyze the first asset message and the second asset message based on at least one criterion;
disregard at least a portion of the second asset message in response to the analyzing; and
refrain from transmitting a relay message to the receiver corresponding to at least one disregarded portion of the second asset message.

16. An asset location system comprising:
an asset tag configured to be attached to an asset and to transmit an asset message according to a wireless communication protocol;
a plurality of relay tags, each of the plurality of relay tags configured to receive the asset message from the asset tag, to determine a received signal strength indication (RSSI) for the asset message, to generate a relay message including an indication of the relay tag, an indication of the asset tag, and the RSSI, and to transmit the relay message;
a receiver configured to receive the relay messages from the plurality of relay tags, to generate a receiver message including content of the relay messages, and to transmit the receiver message; and
a server configured to receive the receiver message from the receiver and to determine a location of the asset tag using content of the receiver message.

17. The asset location system of claim 16 wherein the server is configured to determine the location of the asset tag by assigning, as the asset tag location, a known location of one of the plurality relay tags having a highest RSSI for the asset message.

18. The asset location system of claim 16 wherein the server is configured to determine the location of the asset using trilateration based on known locations of respective ones of the plurality of relay tags and respective ones of the RSSIs determined by the relay tags.

19. The asset location system of claim 16 further comprising a landmark tag configured to send a landmark message to the asset tag using the wireless communication protocol, the landmark message indicating that the system includes the plurality of relay tags.

20. The asset location system of claim 19 wherein the plurality of relay tags comprises the landmark tag.
